(19) United States
(12) Patent Application Publication
(10) Pub. No.: US 2008/0104012 A1
(43) Pub. Date: May 1, 2008

(54) ASSOCIATING BRANDING INFORMATION WITH DATA

(75) Inventors: Sean Patrick Nolan, Bellevue, WA (US); Jeffrey Dick Jones, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/759,359

(22) Filed: Jun. 7, 2007

Related U.S. Application Data
(60) Provisional application No. 60/863,897, filed on Nov. 1, 2006.

(51) Int. Cl. G06F 17/30

(52) U.S. Cl. 707/1; 707/E17.001

(57) ABSTRACT

A platform for associating branding information with data is provided to allow a manufacturer of a data device, or other company, to be recognized for its data contribution to a centralized platform, for example. In this regard, companies have incentive to provide data services to users of the platform as the data can comprise branding information related to the company such as an advertisement, link to a main website or product specific websites, logo, additional data related to a request that is specific to the device, and/or additional data regarding users of similar devices. The branding information is rendered along with the data requested.

### CROSS-REFERENCE TO RELATED APPLICATION(S)

This application claims the benefit of U.S. Provisional Patent Application Ser. No. 60/863,897 filed on Nov. 1, 2006, entitled “INTERACTIVE AND INTUITIVE HEALTH AND FITNESS TRACKING,” the entirety of which is incorporated herein by reference.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular.

For example, collaborative social networking websites have exploded world-wide. These sites allow users to create remotely stored profiles including personal data such as age, gender, schools attended, graduating class, places of employment, etc. The sites subsequently allow other users to search the foregoing criteria in an attempt to locate other users—be it to find a companion with similar interests or locate a long lost friend from high school. As another more practical example, banking websites offer users the ability to remotely store information concerning bills to be paid. By utilizing this feature, users can automatically schedule bill payments to be made from their bank account which will be automatically debited when the payment is scheduled. This allows simultaneous electronic management of account balancing and bill paying such to save the user from manually entering checks into the register of their checkbook.

The foregoing technologies can be beneficial to consumers as shown; however, pooling data from multiple sources for interaction and display can add great benefit in monitoring many different aspects of life by providing unique associations of available information. While aggregating the multiple types and sources of data may benefit consumers, a company, such as a manufacturer of a data input device, may not be apt to provide functionality in a centralized data aggregation system or platform without having some sort of recognition for the data it provided to the system.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A platform for associating data with branding information is provided where data originating from a branded device can be housed within the platform, and information related to the brand of the device can be obtained and stored with the data as well. In subsequent requests made to the platform for access to the data, the data can be submitted to the requesting entity along with the branding information to ensure the manufacturer of the device is credited with computing, generating, or otherwise obtaining the data presented. In one embodiment, the branding information can be an advertisement of the manufacturer, for example. The advertisement can be of many formats and can be rendered by the requesting entity and/or another component that can relay the advertisement to the requesting entity. It is to be appreciated that the branding information can be visual as well as audio.

In another embodiment, the branding information is a link to the manufacturer's main website or any other website(s) that relate to the device from which the data originated or any other device of the manufacturer's. For example, if the user has a device, a link to the website for an improved device can be displayed. The branding information can also be additional information that is available from the branded device in regard to information requested that may not be available in similar devices; a method of rendering and/or acquiring this information can be provided in the branding information. In another embodiment, the branding information can be data related to other users of the device or a similar device to facilitate competition among the users, for example.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary system that facilitates branding data.

FIG. 2 illustrates a block diagram of an exemplary system that brands and stores data.

FIG. 3 illustrates a block diagram of an exemplary system that returns requested branded data.

FIG. 4 illustrates an exemplary rendering of branding information.

FIG. 5 illustrates an exemplary user interface display of branded data.

FIG. 6 illustrates a block diagram of an exemplary environment utilizing a data branding component.

FIG. 7 illustrates an exemplary flow chart for associating branding information with data.

FIG. 8 illustrates an exemplary flow chart for requesting and rendering branded data.

FIG. 9 is a schematic block diagram illustrating a suitable operating environment.

FIG. 10 is a schematic block diagram of a sample-computing environment.

### DETAILED DESCRIPTION

A platform for supporting branding of data is provided where data can be stored in the platform along with branding information; the branding information is sent in subsequent requests and can be rendered by the requesting entity. This provides incentive for manufacturers of data collection and tracking devices to share data, for example in centralized systems, as the appropriate source can be given credit for the data provided. Additionally, this can create an advertising incentive as well where a user accessing data can be apprised of the scope of data available from the devices. In addition, the branding information can offer links to websites for improved products, for example, to users of a given product. In this regard, data shown in conjunction with a device can show blank spaces where different data available in an improved device would be displayed, for example, motivating the user to consider upgrading to the new device.

In one embodiment, a health integration network is provided as a platform comprising multiple databases that respectively store health and fitness data. The health integration network can, for example, allow users of the system to store data related to their workout activity. The user can use a personal fitness device, for example, to track certain data regarding the workout such as heart rate (e.g. using a fitness watch), and the health integration network can be utilized to store this information. The health integration network can also allow the entity or application storing the data to provide branding data to be stored along with the fitness data. Subsequently, the data can be requested by the user or another user who can have access to the data (such as a competitor in a virtual fitness competition and/or a physician/personal trainer) and displayed with the branding information. It is to be appreciated that more than one brand of fitness watch can exist and be used in conjunction with the health integration network; thus, providing the branding functionality allows the manufacture of the watch used to record data to receive credit for computing and storing the data. This incentivizes the different companies to provide access within the health integration network. Additionally, the branding information can also include different kinds of advertisements or even allow the manufacturer to sell the advertisement space to other entities.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

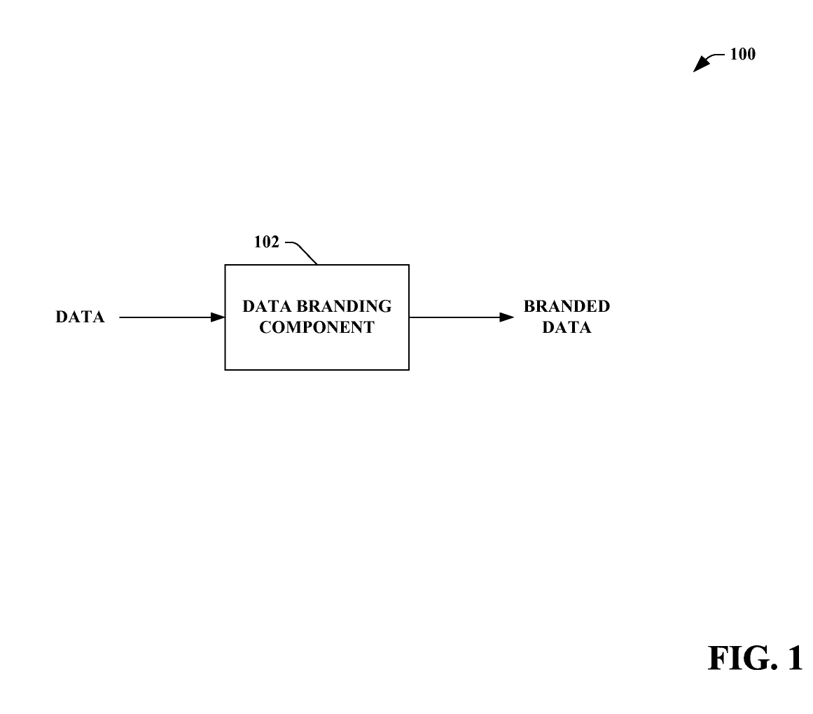

Now turning to the figures, FIG. 1 illustrates a system 100 that facilitates applying branding information to data. Specifically, a data branding component 102 is provided that takes data as input and outputs branded data. In one embodiment, data is input into the data branding component 102 and branding is applied to the data. The branding can be applied as an attachment to the data, for example as at least one data field in a branding structure specified by the data. Additionally, the branding can be applied directly to the data, such as a string concatenation or the like. Furthermore, the data can have one or a series of transforms that describe the data and/or can render the data in different ways; these transforms can be branded themselves and/or comprise instructions for rendering the branding information along with the data.

In one embodiment, the data originates from a brand-name device such as a personal fitness watch and is to be stored in a platform. The watch and/or the platform can input the data into a data branding component 102 to associate the brand of the watch with the data. The branding information can be specified by the watch, the platform, or the data branding component 102 and, as mentioned above, can accompany the data directly (such as a concatenated string or image) and/or as or within an attached rendering instruction. One advantage to having the platform or data branding component 102 specify the branding information is that it is easy changeable, for example, by a remote system. For instance, if the brand is running a promotion, branding information tied to the data can be related to that promotion or a link to the promotion website for a temporary duration.

In addition, where like data is stored by similar but differently branded devices in a centralized platform, for example, the branding information can be specified differently though the data may be of the same type (e.g. otherwise have the same data fields). For example, one fitness watch can be used by a user of the platform and another brand used by another user. The users can view each others data collected from the watch to compare and/or compete, for example. When viewing the others information, the application used to view can display the branding information for the data viewed. In this regard, the brand of the device is getting credit for the data it produced. This can have a marketing benefit where one user may desire data offered by the other user's device and may seek to purchase a device of the same brand. The brand will be evident as the user is viewing the data, and in fact, the branding information can supply the user with an advertisement and/or a link to the brand website. Moreover, the user viewing their own data may not benefit from seeing the ad for the device they have and in this regard the brand can sell ad space to other affiliates to be displayed and/or display an ad for upgraded or improved equipment, for example.

Thus, the data can be used in a centralized system or platform where like data is stored and the source of the data is protected in this regard. Furthermore, this can apply to other cases, for example, where the data need not originate from a branded device, but there may otherwise be a brand associated with the data. For example, the data can be financial institution data concerning personal financial accounts. A checking account can be tied to a debit card, which can be used to make purchases, and the bank can offer a website to view transactions. In one embodiment, retail transactions can be sent from a credit card processing machine to the bank with associated branding information regarding the establishment where the purchase was made. Subsequently, the bank website can, for example, display the branding information when the user is viewing account details. Similar to the embodiment above, the branding information can be a logo and or advertisement for the establishment, but can also be a link to their website and/or printable coupons, for example.

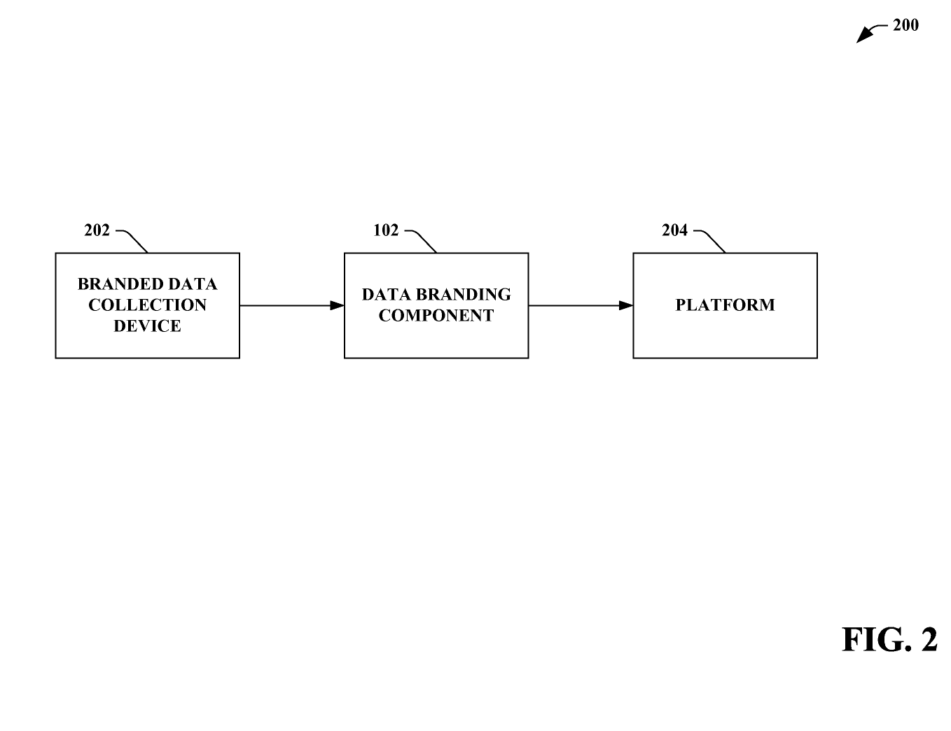

Referring to FIG. 2, a system 200 for storing data and branding information is shown. A branded data collection device 202 is provided that collects, generates, or otherwise manufactures data, a data branding component 102 that associates branding information with data is also provided, and a platform 204 that stores the data and branding information is shown as well. In one embodiment, the branded data collection device 202 can be a personal fitness device (such as a bicycle computer, pedometer, altimeter, fitness watch, heart rate monitor, etc.), exercise equipment (such as an elliptical trainer, treadmill, Stairmaster, rowing machine, stationary bicycle, etc.), a personal heath device (such as a blood pressure monitor, glucose monitor, pacemaker, physical therapy device, etc.), commercial health and fitness devices, or other device(s) that collects health and/or fitness related data. Additionally, the branded collection device 202 can be, or operate in conjunction with, a software application running on a computer or other device.

The branded data collection device 202 can send collected data to the data branding component 102 to have branding information associated with the data. The data branding component can associate the data in many regards, including detecting the device submitting the data and associating the branding information based on the detected device type. The branding information can be stored within the data branding component 102 and/or retrieved from the platform 204. Additionally, where the branding data is stored in the platform 204, the data branding component 102 can merely specify a data type and/or a data branding type and allow the platform 204 to make the association (e.g. send the data along with the branding information) upon subsequent request(s) for the data. Moreover, the branding information can be sent to the data branding component 102 via the branded data collection device 202. It is to be appreciated that one or more of the devices can possess and specify the branding information; additionally logic can be provided such that, for example, the branded data collection device 202 can comprise and submit branding information, but the platform 204 can also comprise and submit (or respond to a request for) branding information. The logic can specify that the platform 204 branding information is a limited time advertisement and should take precedence over the branding information housed in the branded data collection device 202 until the offer period expires, for example. The data branding component 102 can interpret this logic to specify which information is to be used. Alternatively, the platform 204 can execute this logic or a requesting device as well.

The platform 204 can accept data from multiple sources, as mentioned, to allow cross-compatibility such that every user of every device need not have their own application for tracking fitness data. Since the platform 204 can be centralized, a user can view another's fitness data, and the brand of product that input the data can be specified to protect the data shown. In this regard, the brand is associated with the data so when the data is displayed, the viewer knows the source brand. This can provide incentive for companies to utilize the centralized data platform 204 as it is more convenient and robust for users while still protecting the company's data.

In one embodiment, the platform 204 can be a health integration network that stores health and fitness data. In this embodiment the branded data collection device 202 can be, for example, a blood pressure monitor of a certain brand. The blood pressure monitor can be used to take a user's blood pressure, associate branding information with the data via the data branding component 102 and store the branded data in the platform 204. Subsequently, a physician can view the reading and the branding information can be displayed for the brand of monitor the patient used to take the blood pressure. The branding information can be a logo, a link to a website, and/or any other data tied to the brand (including ad space sold to a third party). It is to be appreciated that the branding information can also be specified in other rendering formats such as audio. Thus, the physician can take the patient's blood pressure with the physician's blood pressure monitor, scroll through historical readings resident in the platform 204 (from any device), and the monitor can provide an auditory indication of the monitor used as the doctor reaches each reading. It is to be appreciated that the subject matter is not so limited to the foregoing, rather these are just a few of many example uses.

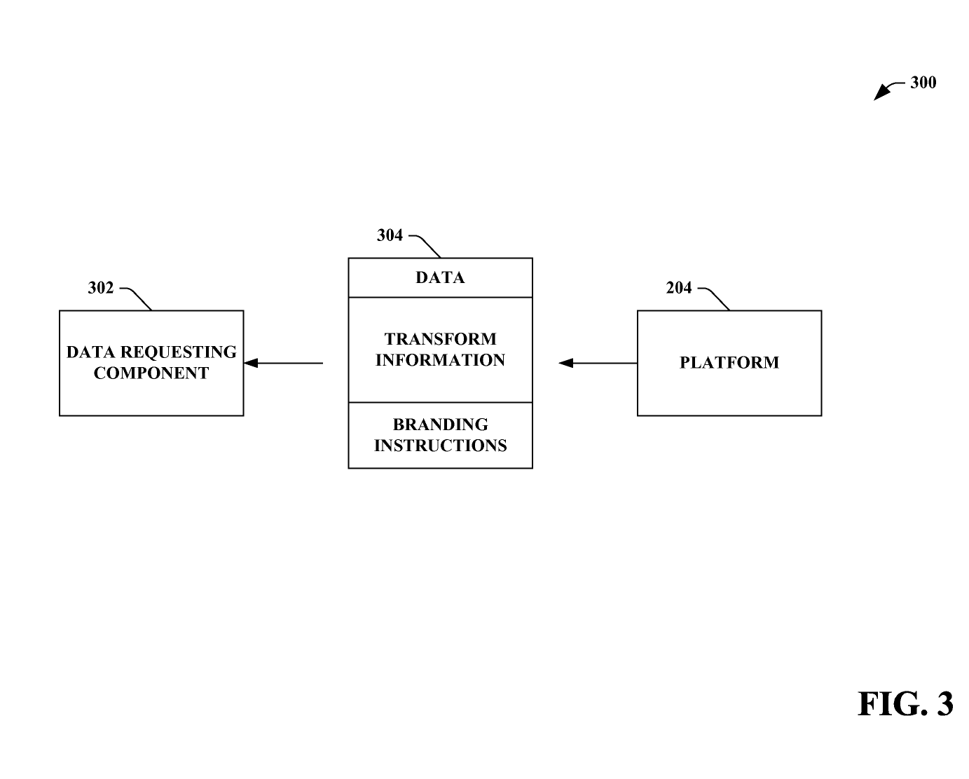

Turning now to FIG. 3, a system 300 that facilitates responding to a request for data with branding information is illustrated. A data requesting component 302 is provided that performs a data request to a platform 204. Additionally, a sample data specification is shown at 304 that represents the data returned by the platform 204 in response to the requested data. In one embodiment, the data requesting component 302 queries the platform 204 for data associated with a branded device. The platform 204 returns the data 304 comprising the data requested, transform information, and branding instructions. It is to be appreciated that the data returned can already have the branding information associated with the data; rather the following is just one possible embodiment.

The data requesting component 302 can be a device and/or application such as the devices and applications listed supra. Additionally, it can be a user interface that utilizes such devices and/or application, or a user interface for a third-party application that can access the platform 204, for example. Additionally, the data requesting component 302 can be an eXtensible user interface or any other display that is able to interpret data that is self-describing such as data 304. For example, the data 304 can be formatted in such a way that transform information can be provided and utilized to render the data in a multitude of different scenarios and contexts. The rendering instructions, code, etc., can be specified by a device storing the data to be subsequently retrieved, for example. In one embodiment, the data is an eXtensible markup language (XML) document having values for each entry related to the requested data. The transform information can comprise one or more stylesheets, such as eXtensible stylesheet language (XSL) or similar technology that describes at least one method for laying out the data. The subject matter is not limited to XSL, however. The transform information can also be executable code (object-oriented, sequential, hierarchical document, SQL, and the like) that can be run to effectuate the transform. It is to be appreciated that the transform information can comprise many transform specifications for a given type of data and the data requesting component 302 can pick the one it wants. These methods are stored in the platform 204 with the data. Additionally or alternatively, the data requesting component 302 can supply at least one compatible method to the platform 204 to be returned instead of a whole list. The platform 204 can be a health integration network as described infra using similar storage techniques for data, types, and transform information.

In addition, the branding instructions can be provided in similar fashion as the transform information as described. In fact, the branding can be part of (e.g. embedded within) one or more available transforms or required by all transforms. In one embodiment, the branding instructions are similar to the transform information in that the instructions can indicate one or more methods for rendering the substantive branding data and the branding data can be part of the data to be rendered. In this regard, the branding instructions can have similar structure or similar placement within the transform information while the actual branding substance can be part of the data and change from record to record depending on the source of the branded data. Additionally, the branding instructions can be executable code that can execute in conjunction with the platform 204, for example, to render one or more branding details.

Moreover, the branding instructions can be transform information themselves, such as additional transforms available. These can comprise a plurality of data values and executable code to derive additional data from the platform 204 and render such in different ways. For example, the platform 204 can be a health integration network that stores health and fitness related data. Data can be stored on behalf of a fitness watch that records data related to running such as time, speed, distance and/or heart rate. It is to be appreciated that some values can be entered in automatically and some manually. Many fitness activities stored in the health integration network will have related data entries such as time, speed, distance, etc.; however, not all of the entries will have the capability of storing heart rate data. Thus, when rendering fitness activities, the time, speed, and distance can be logically shown together for each activity (such as in a table having columns for the data). Providing branded entries as described herein allows a branded device to also store information specific to that device and further render the information when branded entries are engaged. Therefore, as will be described and shown in subsequent figures, though the fitness activities can be grouped together in a table, when entries for the fitness watch are engaged (e.g. mouse-clicked and/or moused-over), additional information regarding the heart rate data can be displayed (e.g. in a pop-up window) in one example. The additional information can also comprise logos, links to manufacturer's website, advertisements, and the like. The additional information can also comprise links to different views of the heart rate data (such as different types of graphs and charts, averages, comparisons with other users, etc.) in different windows and/or web-pages/websites, and the like, or links to other brand-specific data. It is to be appreciated that the branding instructions can provide additional mechanisms for displaying the brand-specific data; this is just one such example.

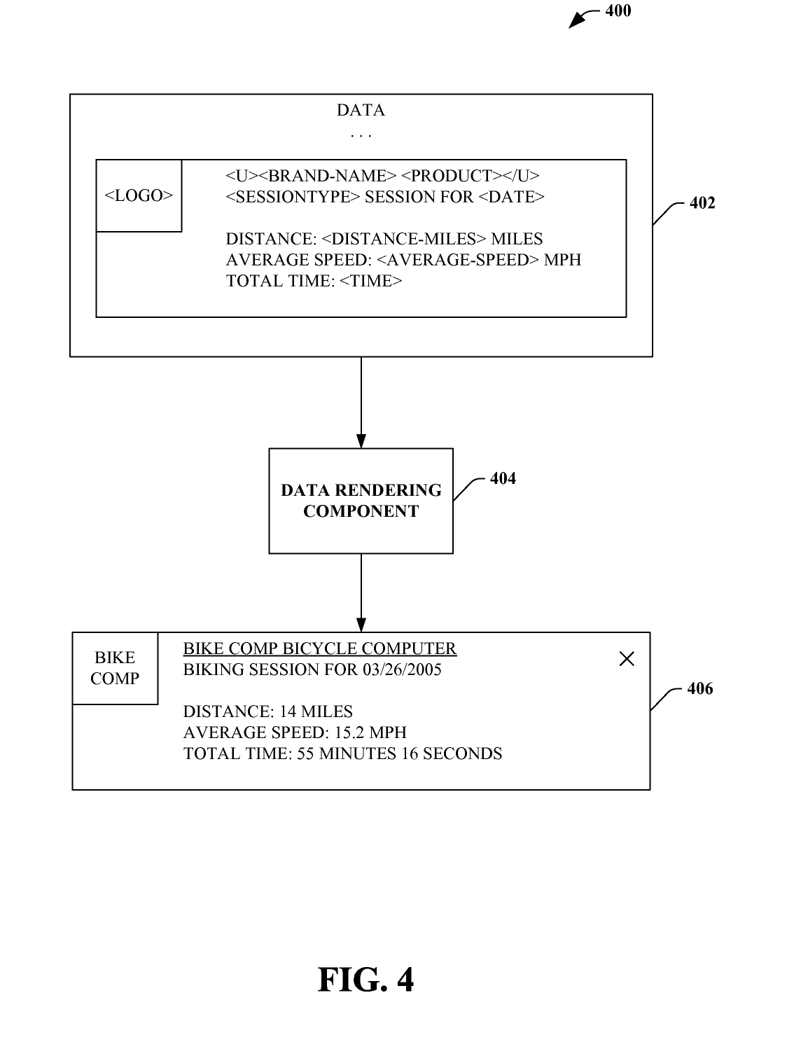

Turning now to FIG. 4, an example system 400 for rendering data with branding information is shown. Data with branding information 402 is shown as well as a data rendering component 404 that takes the data 402 as input and outputs the rendered data 406. In this example, the data 402 is shown with transform information including some branding instructions. The transform information comprises a box in the upper left-hand corner for a logo of the brand. The logo to be placed in the box can be part of the data or inserted as part of the transform information before sending the data 402. The transform information also comprises placeholders for brand-name and product that can be fields in the data to which the information relates. The transform information, as mentioned, can be many types of information and can coexist with disparate types—for example, SVG or graphical instruction equivalents can be used to specify instruction on rendering the logo where XML/XSL can be used for the remainder of the data. The data rendering component 404 can take the data and transform information as input and output the rendered data 406. The rendered data 406 shows the logo, in the upper left-hand corner as well as the brand-name and product (as well as other data related to the fitness activity). In this regard, different data, from a different device for example, can be used with this transform information to render different branding information as supplied with the data 402. Thus, rendering implementation need not be modified to add new brands, logos, advertisements, links to websites, etc.; rather only the branding information, which can be resident in a platform/health integration network, need be changed.

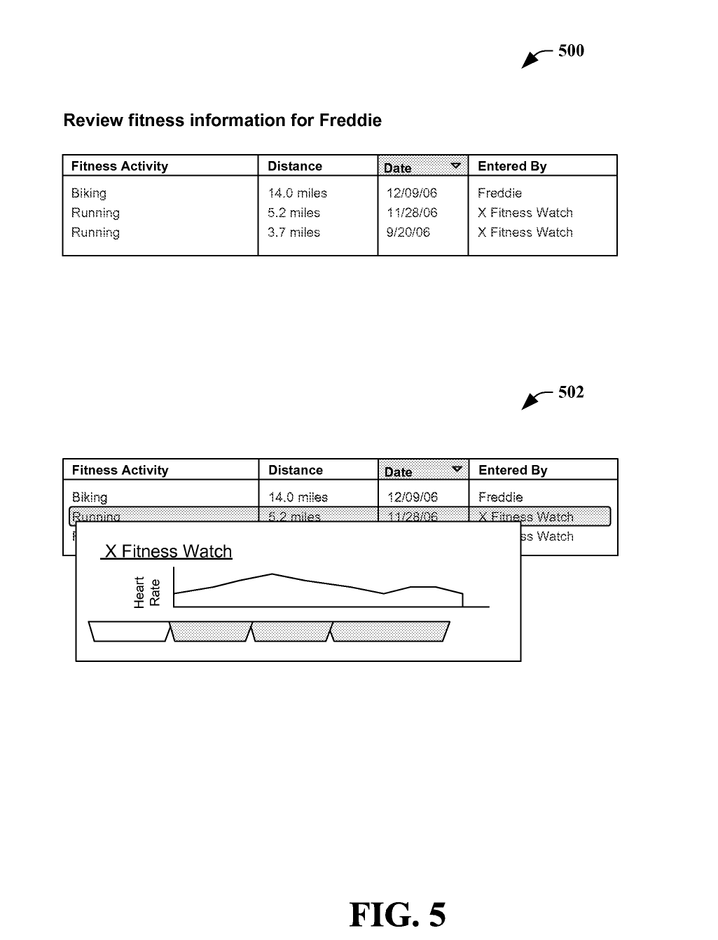

In FIG. 5, an example is presented of a fitness routine information screen in a tabular format 500. The layout of the tabular data, as described above, can be defined as an abstract layout by transform information and rendered as such using the additional substance data. The information is sortable by the fields provided and is shown as sorted by date. At 502, the tabular formatted data is shown with a fitness watch item selected; selection of the item pops up the tabbed window comprising a logo and further detailed information gathered by the branded fitness watch. It is to be appreciated that the subject matter described is not limited to this embodiment, rather this is one possible example screenshot to illustrate brand-specific information being displayed differently from information generic to all of the fitness activities.

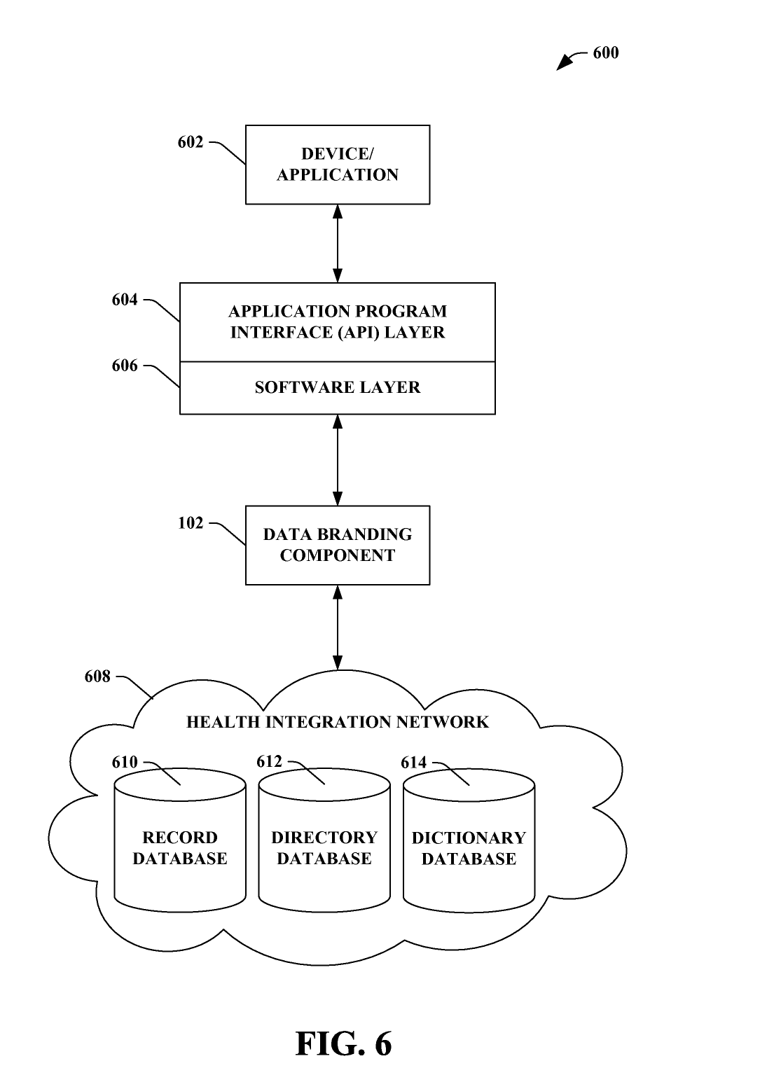

Referring to FIG. 6, an example system 600 that facilitates accessing information within a health integration network is shown. A device/application 602 can be provided that can request and/or provide data. It is to be appreciated that the device/application 602 can be many different types of applications including software applications, electronic devices executing a software application, electronic devices alone, legacy devices interfaceable with a device executing a software application, and the like. The device/application 602 can be a branded device/application and can submit data to a health integration network 608 along with branding instructions and/or information to be associated with the data by the data branding component 102. Requests to store data with branding instructions/information can leverage an application program interface (API) 604 to access the health integration network 608. It is to be appreciated that the API 604 can synchronously or asynchronously communicate with devices/applications 602 of similar or different types. The API 604 can also have a software layer 606 to leverage in interpreting and processing requests to retrieve or store data. The software layer 606 can be separated out as shown, or it can be integrated within the API 604, the health integration network 608, or both. Upon interpreting and processing a request to store data with branding information (that can originate from the device/application 602), the software layer 606 can access the data branding component 102 to associate branding information with the data. This can be data specified by the device/application 602, the API 604, software layer 606, data branding component 102, and/or the health integration network 608; thus, the health integration network 608 for any necessary data or to store necessary data to fulfill the request. The software layer 606 can also provide value-add to the data such as assembling data from the health integration network 608, applying business models or processes in conjunction with data, caching data, and/or applying transformations or additional information to/with the data. It is to be appreciated that there may be a plurality of APIs 604, software layers 606, and/or data branding components 102 connecting to a centralized health integration network 608, and the centralized health integration network 608 may be a single system or distributed across multiple systems, platforms, and the like. The data branding component(s) 102 can also be a part of the health integration network. Additionally, a plurality of data branding components 102 can be leveraged by the API 604 and/or software layer 606 or vice versa.

The health integration network 608 can comprise a plurality of data stores including a record database 610, a directory database 612, and a dictionary database 614. In addition, the health integration network 608 can comprise many other systems and/or layers to facilitate data management and transfer. Furthermore, the databases can be redundant such that multiple versions of each database are available for other APIs and applications and/or a back-up source for other versions of the databases (to provide redundancy, for example). Additionally, the databases can be logically partitioned among various physical data stores to allow efficient access for highly accessed systems. Moreover, the databases can be hierarchically based, such as XML and/or relationally based. The record database 610 can be highly distributed and comprise personal health related data records for a plurality of users. The records can be of different formats and can comprise many kinds of data (single instance, structured or unstructured), such as plain data, data and associated type information, self-describing data (by way of associated schemas, such as XSL schemas for example), data with associated templates (by way of stylesheets for example), data with units (such as data with conversion instructions, binary data (such as pictures, x-rays, etc.), and the like. Moreover, the record database 610 can keep an audit trail of changes made to the records for tracking and restoration purposes. Additionally, many data types or related instances of the foregoing information can be stored in a disparate database such as the dictionary database 614 described infra. The record database 610 can be partitioned, distributed, and/or segmented based on a number of factors including performance, logical grouping of users (e.g. users of the same company, family, and the like).

The directory database 612 can store information such as user account data, which can include user name, authentication credentials, the existence of records for the user, etc. The directory database 612 can also house information about records themselves including the user to whom they belong, where the record is held (in a distributed record database 610 configuration) authorization rules for the records, etc. For example, a user can specify that a spouse have access to his/her fitness related data, but not medical health related data. In this way, a user can protect his/her data while allowing appropriate parties (such as spouse, doctor, insurance company, personal trainer, etc.) or applications/devices (blood pressure machine, pacemaker, fitness watch, etc.) to have access to relevant data. In addition, the directory database 612 can comprise data regarding configuring a device/application 602 to interact with the health integration network 608; devices/applications 602 can be required to register with the health integration network 608, and thus, the device/application 602 data in the directory database 612 can include the registration information.

The dictionary database 614 can hold information relating to vocabulary definitions used by the health integration network 608 and requesting entities such as the API 604, software layer 606, and device/application 602. Such definitions can include data type definitions and information on how to display the different data types or transform them. Additionally, the dictionary database 614 can hold information for display layouts and templates, etc. The dictionary database 614 can also house branding instructions for different types of data as described herein. Furthermore, the dictionary database 614 can hold different look-up tables that define codes through the use of standards and the like. For example, the dictionary database 614 can support International Classification of Diseases, ninth revision (ICD-9) released by the National Center for Health Statistics. These codes identify different diseases and diagnoses; thus a doctor can put one of these codes on a user's chart in the health integration network 608, and the dictionary database 614 can allow the software layer 608 (or API 606 and/or device/application 602) to translate this code into something that makes more sense to the user, such as medical name and/or different, other, or additional information concerning the diagnosis. The dictionary database 614 can also be used to retrieve other metadata such as plural and abbreviated forms of codes (such as ICD-9 codes). It can also hold information that allows conversion between different measurement units, such as between feet to meters, Fahrenheit to Celsius, pounds to kilograms, etc. For example, the dictionary database 614 can also hold values for the self-describing rendering information as described above (including XML code, object-oriented code, pseudo-code, XSL, etc.) as well as branding information such as logos, advertisements, links to websites, brand-specific data capabilities, etc.

In one embodiment, the device/application 602, which can be more than one application, device, and/or user utilizing a GUI for example, can request storage of data to the API 604. The API 604 can leverage the software layer 606, for example, to request to the data branding component 102 that branding instructions be associated with the data. As mentioned supra, the branding instructions can originate from the device/application 602, the data branding component 102, the health integration network 608, the API 604, the software layer 606 or any combination thereof. Additionally, branding logic can be employed to choose one over the other(s) where more than one is specifying the branding data. The data is then stored in the health integration network 608 with the branding instructions. It is to be appreciated that the branding instructions can be stored with available types and transform information in the dictionary database 614 for example. Subsequently, the same or different device/application 602 can request the data that was stored from the API 604. The API 604 leverages the software layer 606 to process the call made by the device/application 602. The software layer 606 can then query its own internal cache or the health integration network 608 for desired data; additionally or alternatively, the software layer 606 can directly query one or a plurality of the databases 610, 612, and 614 for the desired data. The software layer 606 can serially or asynchronously query for data until all data is obtained from the health integration network 608. The software layer 606 can then manipulate portions of the data using other data it has obtained to formulate the result desired and return that result to the device/application 602 via the API 604. The resulting data comprises the branding instructions, which can be in one of the various forms described herein, and the device/application 602 renders the data with at least a portion of the branding information. It is to be appreciated that another component, such as a rendering component, can sit in front of the device/application 602 (or be a part of the device/application 602) to render the data in a manner understood by the device/application 602. Such rendering instructions can be part of the transform information comprising the branding instructions.

For example, the device/application 602 can be a bicycle computer that stores data related to at least one bicycle ride. The bicycle computer can request storage of data within the health integration network 608 by calling the API 604 (or a software development kit that can utilize the API 604, for example). The API 604 can leverage the software layer which can call the data branding component 102 to associate the bicycle brand information with the data. The brand information can be stored in the health integration network 608, for example and the data branding component 102 can detect the type of bicycle computer from data sent with the request for storage for example. Additionally, the bicycle computer can specify the complete branding information with the request. The data branding component 102 associates the branding instructions and stores the data with the instructions within the health integration network 608. For example, the data and substantive branding data can be stored within the record database 610 and the branding instructions are stored with the appropriate type in the dictionary database 614. Subsequently, an application with a graphical user interface, for example, can request the stored data from the API 604. The data request is forwarded to the health integration network 608 (perhaps through the software layer 606), and the health integration network 608 gathers the data from the record database 610 as well as the transform and branding information from the dictionary database 614. As described, the branding instructions can be part of the transform information or separate. In addition, the branding instructions can act as transform information for the transform information such that they are inserted within the transform information upon request and sent with the data. For example, the branding instructions can be placement of a logo and upon request of the data related to the brand, the logo can be placed in the transform instructions (at least one or even all) such that it is part of the transform when it is applied to the data at the device/application 602 end. In any case, the requested data and transform information/branding instructions are sent back to the device application 602 (and/or a rendering component) via the software layer 606 and the API 604.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

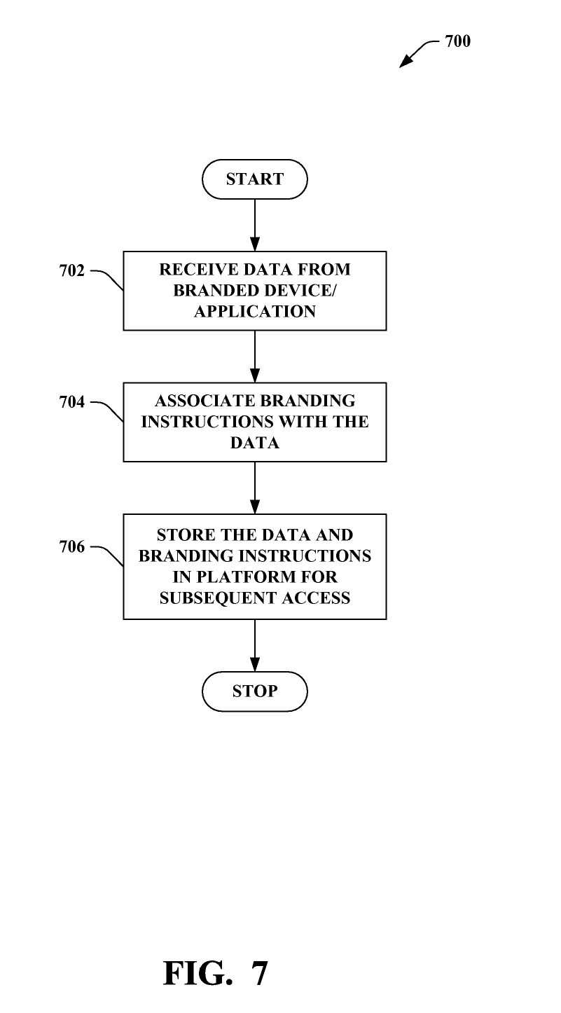

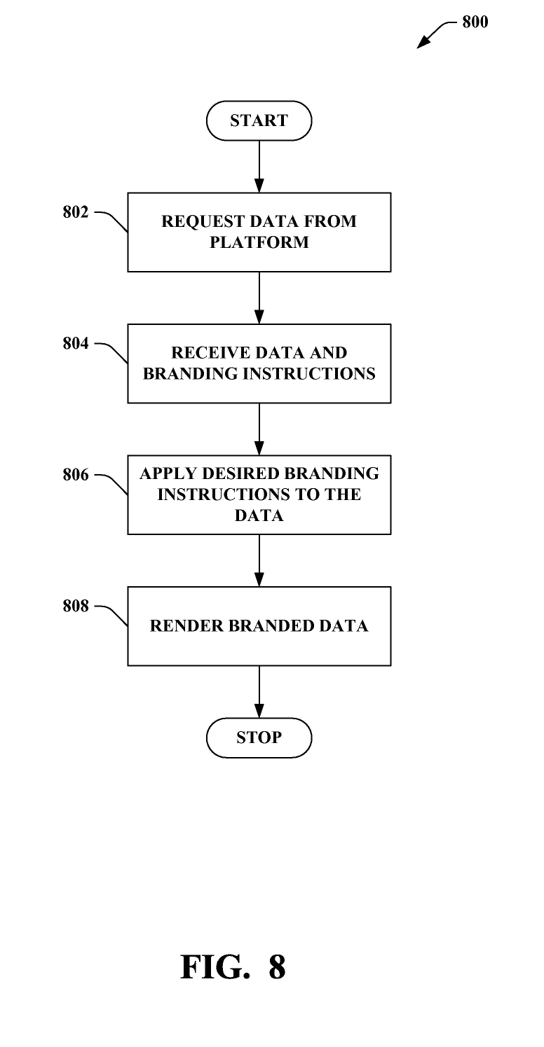

In view of the exemplary systems described supra, methodologies that may be implemented in accordance with the disclosed subject matter will be better appreciated with reference to the flow charts of FIGS. 7-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 7 shows a methodology 700 for receiving data to be stored with branding information. At 702, the data is received from a branded device/application. The device/application can be, for example, any device or application as described above such as a personal health/fitness device, fitness equipment, hospital equipment, etc. At 704, branding instructions are associated with the data; the branding instructions can originate from a plurality of sources including the branded device itself. The branding instructions can also be those stored in a health integration network in connection with previous requests for storage, for example. The data can be different, however, in regard to each storage as a portion of the data. For example, the branding instructions can place a logo in a location of the rendering of the data; however, different data requests can supply different logos to be rendered. In this regard, the data branding instructions can change by merely changing stored data and not requiring further implementation of any software or system to effectuate change in the branding instructions. Thus, the branding information can be tied to each individual data record by specifying different substantive branding data to be rendered by the branding instruction(s).

As described, the branding instructions can be one or more of a logo to be placed in a two-dimensional representation of display data, an auditory indication, an advertisement, links to a manufacturer's website (to other products as well), ads leased to other entities, and the like. The data can also be rendering information specific to the brand, for example, where the brand can comprise and store data at greater levels of granularity than other systems can provide. In this regard, common data to like entries can be displayed along with the more granular information for the different branded types. This can help take advantage of the full functionality of products as well as provide some advertisement of its own about functionality available with the product, for example where a user is viewing another user's data. At 706, the data and branding instructions are stored within a platform, such as a health integration network, for subsequent access.

FIG. 8 shows a methodology 800 for requesting data from a platform where the data comprises branding information. At 802, the request for data is made to a platform. At 804, the data is received along with branding instructions. As described, the branding instructions can be a set of instructions for one or more types of rendering. For example, one or more logos can be provided, some text about the product, links to manufacture's website(s), links to other user's similar data (to facilitate competition, for example), and the like. The branding instructions can also comprise data specific to the brand for additional rendering. At 806, the branding instructions are applied to the data to associate the branding instructions provided with the data. This can indicate the origin of the data and provide advertisement of the origin such to incentivize companies to use a platform where data can be shared while keeping the source of the data protected.

Additionally, the ad space can be rented to other entities as well to provide another monetization aspect, for example, where a user already has the equipment and would benefit more from a different advertisement. Additionally or alternatively, the branding instructions can provide an advertisement for an improved product put out by the manufacturer. Also, it is to be appreciated that both forms of branding instruction can be provided and the rendering device or application can choose which one to render. Moreover, logic can be employed to pick one; for example the brand can sell half-time ad space such that half of the time the branding instruction of the improved product from the manufacture is chosen for rendering and the other half the sold space is shown. At 808, the branded data is rendered.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

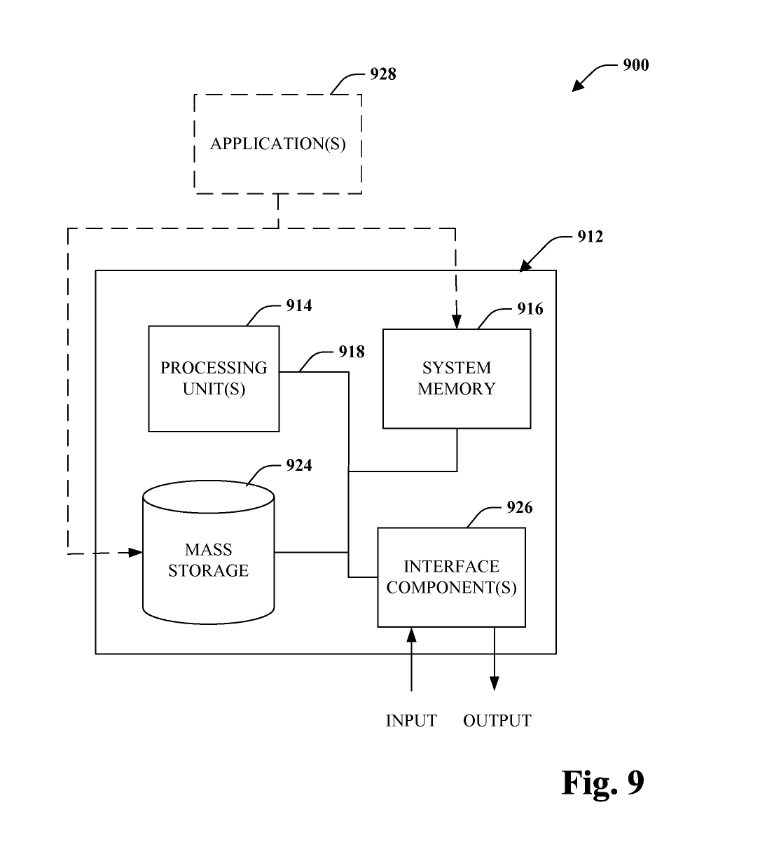

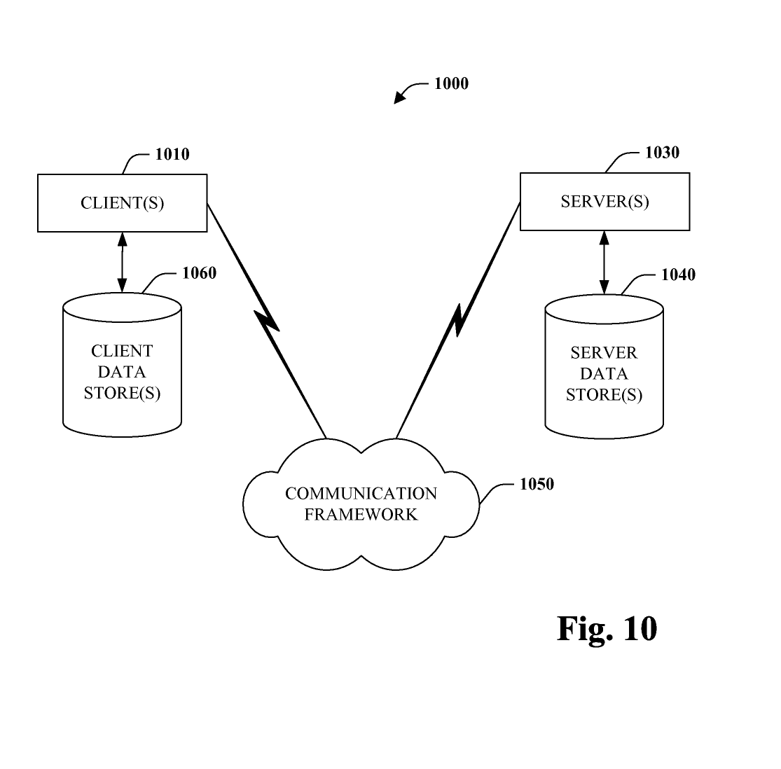

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 900 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 900. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. Here, the client(s) 1010 can correspond to program application components and the server(s) 1030 can provide the functionality of the interface and optionally the storage system, as previously described. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

By way of example, a personal fitness device or a fitness tracking application in accordance with the subject matter as described herein can be executed on or as a client 1010. The device can request to store data associated with a branded device (such as the personal fitness device) to one or more servers 1030 (which executes a virtual scenario component) over the communication framework 1050. The server(s) 1030 can receive the data along with branding information and store them within a data store 1040 or a plurality of data stores (such as a portion of a health integration network). Subsequently, a client(s) 1010 can request access to the data stored the data within the server(s) 1030, which can be returned with the branding information.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for associating data with branding information, comprising:
a platform that houses data originating from a plurality of disparately branded devices; and
a data branding component that specifies branding information related to the data and at least one of the plurality of disparately branded devices to which the data relates, the branding information is stored within the platform and displayed in at least one subsequent request for the data.

2. The system of claim 1, further comprising a data requesting component that requests data from the platform.

3. The system of claim 2, the platform returns data to the data requesting component based at least in part on the request, the return data includes the branding information.

4. The system of claim 1, the branding information comprises at least one logo indicating the source of the data.

5. The system of claim 1, the branding information comprises at least one method to obtain substantive brand-specific data related to the subsequent request.

6. The system of claim 1, the branding information comprises at least one link to a website related to a manufacturer of the at least one of the plurality of disparately branded devices.

7. The system of claim 1, the branding information comprises executable code to obtain comparison data of other users utilizing similarly branded devices.

8. The system of claim 1, the branding information is comprised within at least one transform that provides instruction regarding rendering the data.

9. The system of claim 7, the transform is at least one eXtensible stylesheet language (XSL) document used to render the data in a readable format.

10. The system of claim 1, the platform is a health integration network that stores data originating from a plurality of disparate devices and applications, the health integration network comprises a plurality of databases that respectively store health and fitness data.

11. A method for associating data with at least one brand, comprising:
specifying at least one branding instruction to be associated with data housed in a platform, the branding instruction relates to a branded device from which the data originated;
storing the branding instruction within the platform; and
sending the data along with the branding instruction in response to a request for the data.

12. The method of claim 11, further comprising storing substantive branding data as part of the data in the platform, the substantive branding data is utilized in rendering the branding instruction.

13. The method of claim 11, the branding instruction is comprised within transform information, a portion of the transform information is utilized to render the data to a display.

14. The method of claim 13, the transform information is an eXtensible stylesheet language (XSL) document.

15. The method of claim 13, further comprising rendering the data according to the transform information and providing additional brand-specific data in accordance with the branding instruction.

16. The method of claim 11, the branding instruction is a link to a website of a manufacturer of the branded device.

17. The method of claim 11, the branding instruction is executable code that gathers additional data from the platform.

18. The method of claim 17, the additional data includes that originating from similar branded devices of disparate users.

19. A system for branding data, comprising:
means for obtaining branding information associated with stored data, the data originates from a plurality of disparately branded devices;
means for packaging the branding information with the stored data; and
means for displaying the branding information in connection with a request for the stored data.

20. The system of claim 19, further comprising means for updating the branding information.
